(19) United States
(12) Patent Application Publication
(10) Pub. No.: US 2013/0256062 A1
(43) Pub. Date: Oct. 3, 2013

(54) LUBRICANT RESERVOIR REFILLING SYSTEM WITH SHUT-OFF

(71) Applicants: Jeffrey Mark Kotyk, St. Louis, MO (US); Paul G. Conley, St. Louis, MO (US)

(72) Inventors: Jeffrey Mark Kotyk, St. Louis, MO (US); Paul G. Conley, St. Louis, MO (US)

(73) Assignee: LINCOLN INDUSTRIAL CORPORATION, St. Louis, MO (US)

(21) Appl. No.: 13/431,504

(22) Filed: Mar. 27, 2012

(51) Int. Cl. F16N 19/00; F16N 29/00; F16K 21/18; F16N 7/38

(52) U.S. Cl. 184/36; 137/386

(57) ABSTRACT

A lubricant reservoir system. The system includes a reservoir for containing lubricant. The reservoir has a top, a bottom, a peripheral wall, and an inlet for delivering lubricant to the reservoir from a supply. The system also includes a follower in the reservoir slidingly and sealingly engaging the peripheral wall of the reservoir, the follower moving up and down in the reservoir in response to a changing level of lubricant in the reservoir. The lubricant reservoir system has a shut-off valve in fluid communication with the inlet for selectively preventing lubricant flow through the inlet. The valve is operatively connected to the follower for closing the valve and preventing lubricant flow through the inlet when lubricant in the reservoir reaches a predetermined level.

### FIELD OF THE INVENTION

This invention relates to lubricant reservoirs, and more particularly to a system for refilling a lubricant reservoir from a supply of lubricant.

### BACKGROUND OF THE INVENTION

Pumps such as those shown in the following U.S. Pat. Nos. 2,187,684; 2,636,441; 2,787,225; 3,469,532; 3,502,029; 3,945,772; 4,487,340; 4,762,474; and 6,102,676, operate to pump lubricant from a reservoir. When the amount of lubricant in the reservoir is depleted, the reservoir must be refilled with lubricant. The reservoir is typically refilled via hoses attached to a supply of lubricant. Often, the supply is located some distance from the reservoir. For example, the reservoir may be located in a building and the supply may be located in a truck outside the building. To avoid overfilling the reservoir, the user must stop pumping lubricant from the supply when the amount of lubricant in the reservoir reaches a certain level. Currently, the user is notified that the reservoir is filled when lubricant starts draining out of the reservoir through an overfill outlet. In other systems, the user is notified by a light on the reservoir, which can be difficult to see because of the distance between the reservoir and the pump on the supply. Other systems include an expensive and complex electric shut-off system. Although systems such as those described above have been commercially successful, there is a need for a reservoir refilling system including an inexpensive and relatively simple shut-off mechanism.

### SUMMARY OF THE INVENTION

In one aspect, the present invention includes a lubricant reservoir system, comprising a reservoir for containing lubricant. The reservoir includes a top, a bottom, a peripheral wall, and an inlet for delivering lubricant to the reservoir from a supply. The system also includes a follower in the reservoir slidingly and sealingly engaging the peripheral wall of the reservoir, the follower moving up and down in the reservoir in response to a changing level of lubricant in the reservoir. Further, the lubricant reservoir system has a shut-off valve in fluid communication with the inlet for selectively preventing lubricant flow through the inlet. The valve is operatively connected to the follower for closing the valve and preventing lubricant flow through the inlet when lubricant in the reservoir reaches a predetermined level.

In another aspect, the present invention includes a lubricant reservoir system, comprising a reservoir for containing lubricant. The reservoir includes a top, a bottom, a peripheral wall, and an inlet adapted for receiving lubricant to fill the reservoir. Further, the system comprises a follower in the reservoir above lubricant in the reservoir. The follower moves up and down in the reservoir in response to a changing level of lubricant in the reservoir. The system also includes a shut-off valve operatively connected to the reservoir inlet. The shut-off valve has an open position permitting flow of lubricant to the inlet of the reservoir and a closed position preventing flow of lubricant to the inlet of the reservoir. In addition, the lubricant reservoir system has an actuator positioned in the reservoir and operatively connected between the follower and the shut-off valve for opening and closing the valve in response to movement of the follower to a predetermined level of lubricant in the reservoir.

Other objects and features will be in part apparent and in part pointed out hereinafter.

### BRIEF DESCRIPTION OF THE DRAWINGS

FIG. 1 is a perspective of a lubricant reservoir refilling system of one embodiment of the present invention illustrating a follower in a lowered position;

FIG. 2 is a perspective similar to FIG. 1, but illustrating the follower in a raised position;

FIG. 3 is an enlarged cross section of the system showing a shut-off valve in an open position;

FIG. 4 is an enlarged cross section of the system showing a shut-off valve in a closed position;

FIG. 5 is a schematic illustration showing a first stage of operation of the lubricant reservoir refilling system;

FIG. 6 is a schematic illustration showing a second stage of operation of the lubricant reservoir refilling system; and

FIG. 7 is a schematic illustration showing a third stage of operation of the lubricant reservoir refilling system.

Corresponding reference characters indicate corresponding parts throughout the drawings.

### DETAILED DESCRIPTION

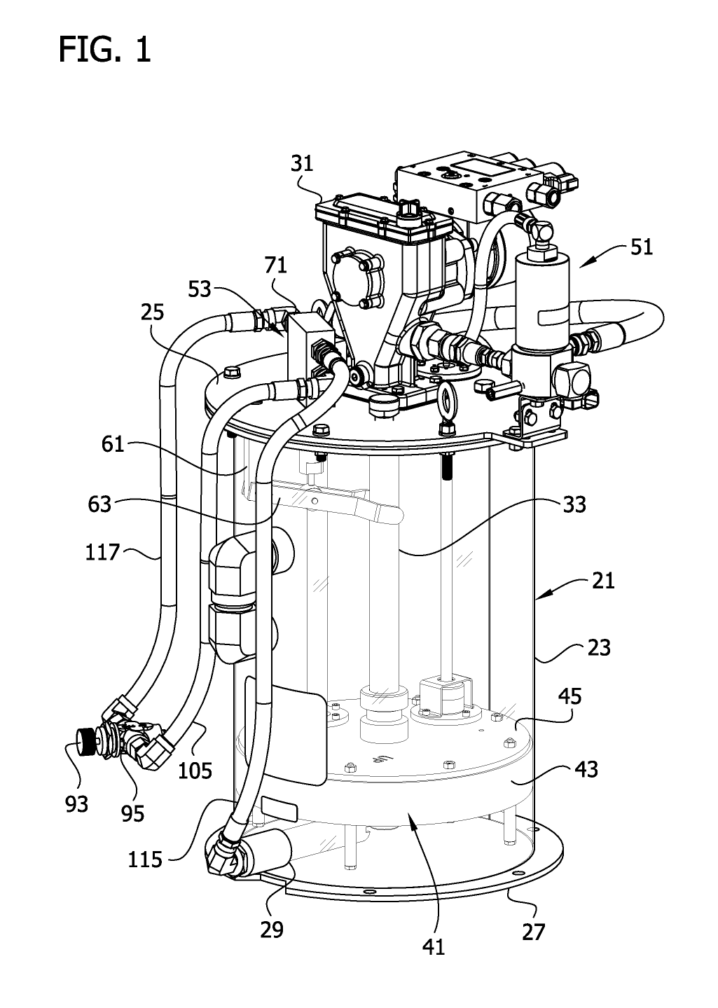

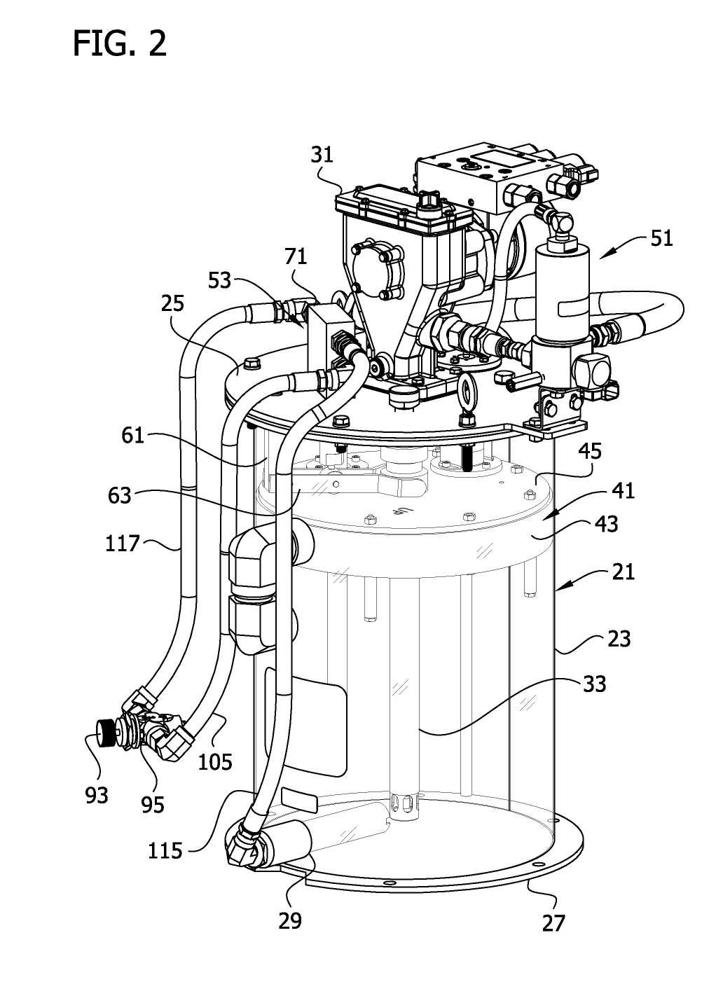

Referring to FIGS. 1 and 2, a reservoir or drum of the present invention, constructed particularly for retaining lubricant, especially grease, is designated in its entirety by the reference number 21. The reservoir 21 comprises a generally circular peripheral wall 23 closed at an upper end by a removable top plate or lid 25 and closed at a lower end by a bottom plate 27. An inlet 29 is provided in the peripheral wall 23 near the bottom 27 of the reservoir 21 for refilling the reservoir. The reservoir 21 can be made of metal, such as steel, or any other suitable material known in the art. The reservoir 21 can be any size, and in one embodiment has a sixteen inch diameter. A pump 31 including a lance structure 33 is mounted on the top 25 of the reservoir 21 so the lance structure extends down into the reservoir toward the bottom plate 27 through a hole (not shown) in the top. The pump 31 can be any pump suitable for pumping lubricant, especially grease. For example, in one embodiment the pump 31 is a Flow Master® lance pump sold by Lincoln Industrial Corporation of St. Louis, Mo. Although a lance pump is illustrated, other types of pumps suitable for use with a reservoir are envisioned as also being within the scope of the present invention. The reservoir 21 is filled with lubricant (e.g., grease) pumped to the inlet 29 from a supply (not shown). The reservoir 21 includes an actuator for closing a shut-off valve to stop the flow of lubricant into the reservoir when the reservoir is filled. The lubricant is then pumped out of the reservoir 21 by the pump 31 for use. When the lubricant contained in the reservoir 21 is depleted, the reservoir is refilled by again pumping lubricant to the inlet 29 from a supply.

As also shown in FIGS. 1 and 2, a follower 41 is provided in the reservoir 21 for pressurizing the grease, as is known in the art. The follower 41 also wipes grease from an inside surface of the peripheral wall 23 of the reservoir 21 as the level of lubricant falls. The follower is constructed for slidingly and sealingly engaging the peripheral wall 23. In one embodiment, the follower 41 comprises a two inch thick elastomer foam insert 43 mounted on a top metal plate 45. As will be appreciated by those skilled in the art, the follower may have other configurations and constructions without departing from the scope of the present invention. The lance structure 33 of the pump 31 extends through a central hole (not shown) in the follower 41 so the follower slidingly and sealingly engages the lance structure. The follower 41 bears against the lubricant contained within the reservoir 21 and moves up and down with the level of the lubricant in the reservoir.

As further illustrated in FIGS. 1 and 2, a conventional vent valve, generally designated 51, is mounted on the top plate 25 of the reservoir 21. As the vent valve 51 is conventional, it will not be described in further detail.

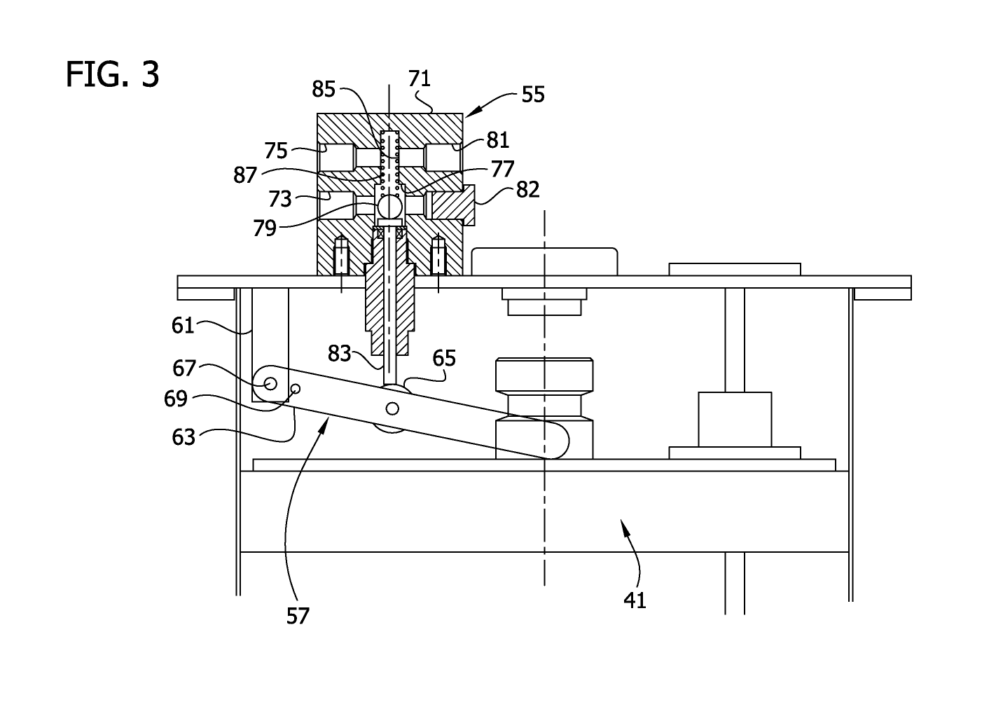

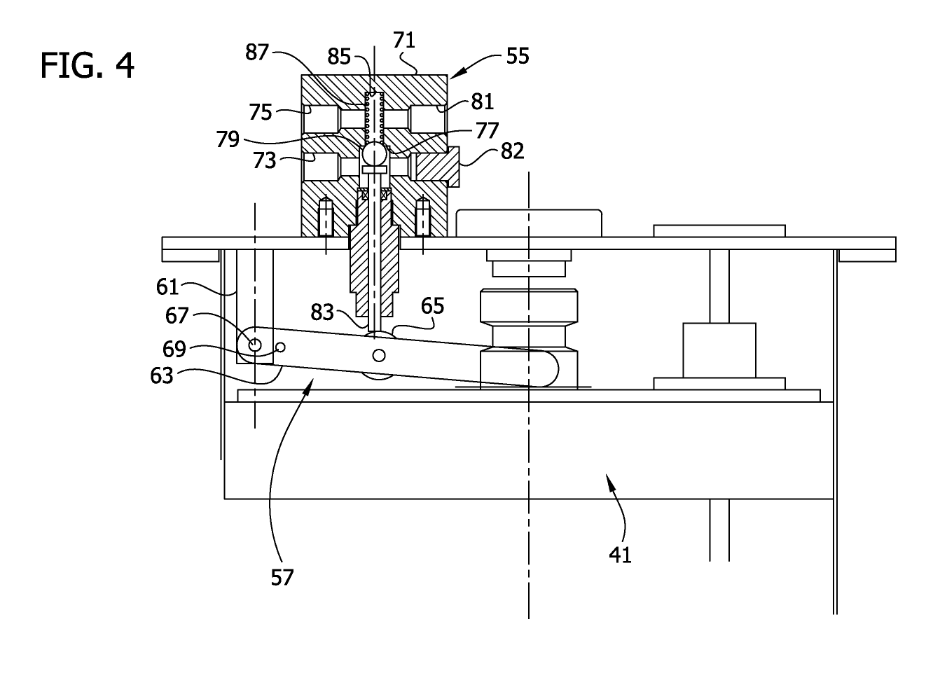

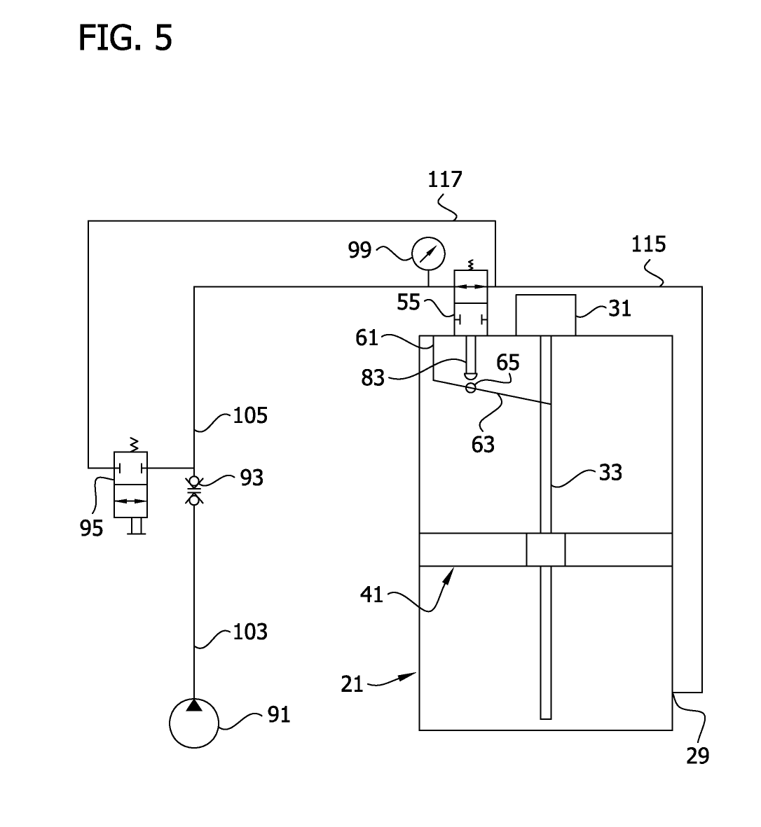

A shut-off valve system, generally designated 53, is also mounted on the top plate 25 of the reservoir 21 for stopping the flow of lubricant into the reservoir when the reservoir is filled. As shown in FIGS. 3 and 4, the shut-off valve system 53 includes a shut-off valve, generally designated 55, and an actuator, generally designated 57, for closing the shut-off valve and stopping the flow of lubricant into the reservoir 21. The actuator 57 includes a mount 61 extending down into the reservoir 21 from the top plate 25 generally adjacent the peripheral wall 23 of the reservoir. A lever comprising a lever arm 63 is pivotably attached at 67 to a lower end of the mount 61 and extends (e.g., slopes downward) toward the center of the reservoir 21. The lower end of the lever arm 63 is positioned so the follower 41 engages the lever arm when it is raised as shown in FIGS. 2-4, but the lever arm hangs freely when the follower is lower as shown in FIG. 1. As shown in FIGS. 3 and 4, the lever arm 63 ideally contacts the follower 41 near the center of the follower to avoid tilting the follower due to pressure from the lever arm. The lever arm 63 includes a roller 65 rotatably mounted on the arm in a position to engage the shut-off valve 55 as will be described below. When the follower 41 falls, the lever arm 63 pivots down under its own weight to a resting position shown in FIGS. 1 and 5. The lever arm 63 includes a stop 69 that engages the mount 61 to prevent the lever arm from dropping below a predetermined angle, such as the angle shown in FIG. 1.

The shut-off valve 55 includes a body 71 having an inlet 73, an outlet 75, and a valve seat 77 positioned in a passage 85 connecting the inlet and the outlet. A movable valve member (e.g., ball) 79 is positioned in the passage 85 adjacent the seat 77 for selectively engaging the seat to close the shut-off valve 55, i.e., to prevent flow through the inlet 73 to the outlet 75. The body 71 also includes a pressure relief passage 81 in fluid communication with the outlet 75 and a plug 82 aligned with the inlet 73. In one embodiment, a pressure gage is aligned with the inlet 73 instead of a plug. As further shown in FIGS. 3 and 4, a rod 83 is slidingly received in the passage 85 in the body 71. The rod 83 is positioned so the roller 65 on the lever arm 63 engages the lower end of the rod as the follower 41 raises the arm. An upper end of the rod 83 is positioned to engage the valve member 79 and to move it to a position against the valve seat 77 to close the shut-off valve 55 when the follower 41 is in the position shown in FIG. 4, preventing flow of lubricant from the inlet 73 to the outlet 75. When the lever arm 63 is lowered to the position shown in FIG. 3, the rod 83 allows the valve member 79 to move away from the seat 77. This movement opens the shut-off valve 55, permitting a flow of lubricant from the inlet 73 to the outlet 75. In one embodiment, a spring 87 is provided in the passage 85 for pushing the valve member 79 away from the seat 77.

As illustrated in FIG. 5, lubricant is pumped by a supply pump 91 from a supply (not shown) to the inlet 29 of the reservoir to refill the reservoir. A quick disconnect coupling 93 is positioned between the supply pump 91 and the inlet 29 of the reservoir 21 to disconnect the supply pump 91 from the inlet 29 once the reservoir is full. A hand-actuated pressure relief valve 95 is provided between the pressure relief passage 81 of the shut-off valve 55 and the quick disconnect coupling 93 to relieve pressure in the corresponding line 97 before disconnecting the coupling. The pressure relief valve 95 preferably vents back to a useful place, such as into the reservoir 21. Thus, no lubricant is wasted or drained in a dangerous or environmentally hazardous manner. As illustrated, the pressure relief valve 95 vents back into the inlet 29 of the reservoir 21. However, other configurations are envisioned that are within the scope of the present invention. For example, the pressure relief valve can vent back to the reservoir 21 through a separate inlet, or to another useful place, such as back to the supply. A pressure gage 99 is in fluid communication with the pressure relief valve 95 (see FIGS. 5-7) allowing a user to determine when the coupling 93 can be safely disconnected. As described above, in one embodiment, the pressure gage 99 can be aligned with the inlet 73 of the shut-off valve 55. The pressure relief valve 95 as illustrated in FIGS. 5-7 is a two-way valve.

Operation of the lubricant reservoir refilling system will now be described with reference to FIGS. 5-7. FIGS. 5-7 depict a system that operates functionally equivalent to the system illustrated in FIGS. 1-4 but has structural differences. A supply line 103 connects the pump 91 to the quick disconnect coupling 93. A line 105 on an opposite side of the coupling 93 communicates fluid to shut-valve 55. Lubricant passing through the shut-off valve 55 travels to the inlet 29 via line 115. The pressure relieve valve 95 is connected to line 115 by line 117. When the reservoir 21 is empty, the follower 41 is in a lowered position in the reservoir. The valve member 79 is spaced from the seat 77 and the shut-off valve 55 is open, permitting lubricant to flow to the inlet 29 of the reservoir 21. The pressure relief valve 95 is closed preventing lubricant flow through the pressure relief valve and through line 117. With the valves 55, 95 in these positions, the reservoir 21 is filled with lubricant pumped by the supply pump 91 to the inlet 29. Lubricant travels into the reservoir 21 via line 115.

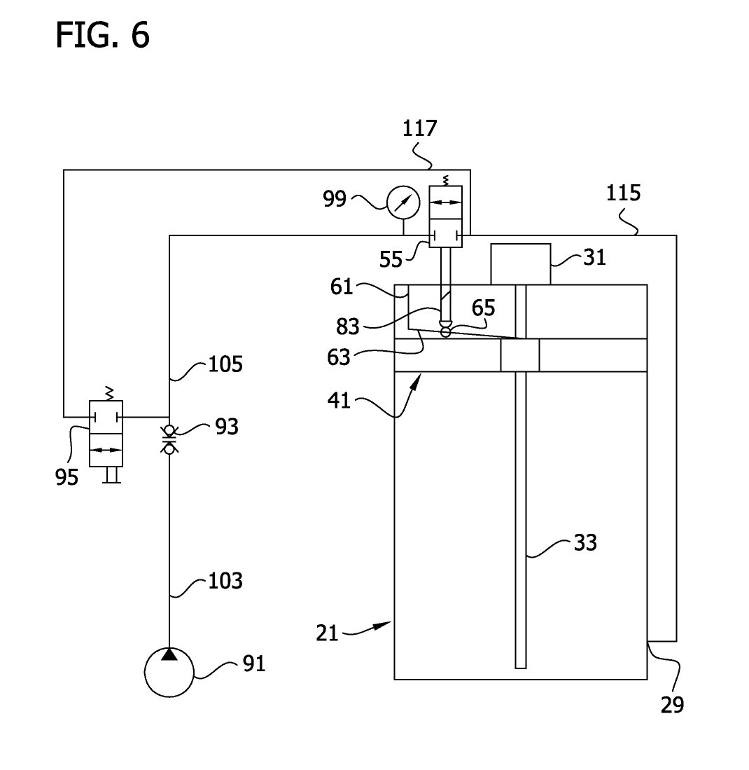

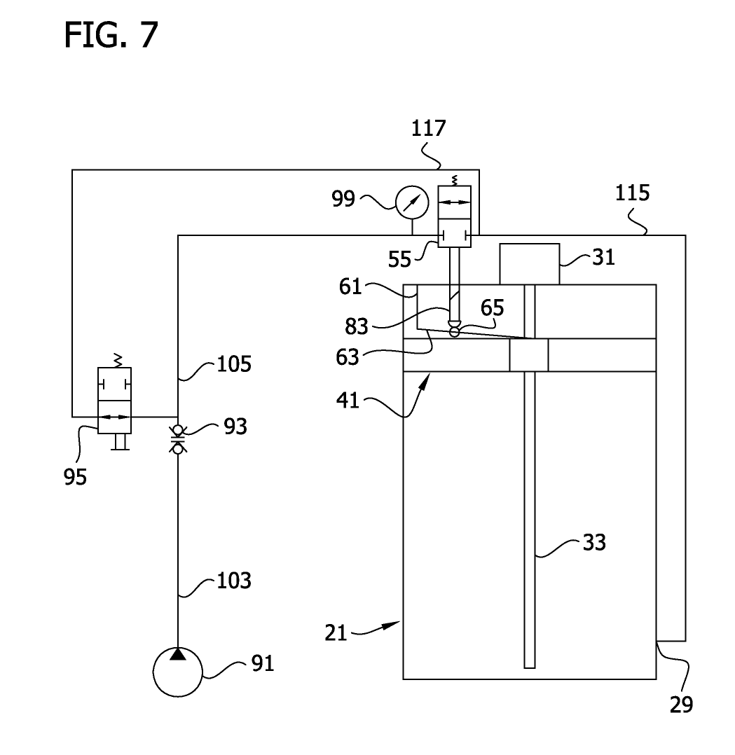

As the level of lubricant in the reservoir 21 rises, the follower 41 rises. When the lubricant in the reservoir 21 nears the top of the reservoir, the follower 41 contacts the lever arm 63 and pushes the lever arm upward. As the level of lubricant and the follower 41 continue to rise, the roller 65 pushes the rod 83 upward, forcing the valve member 79 against the valve seat 77 to block additional lubricant from passing from the inlet 73 to the outlet 75. This condition is illustrated in FIG. 6. The user will then shut off the supply pump 91. The user then manually activates the pressure relief valve 95, moving the valve to the position shown in FIG. 7 so lubricant in lines 103 and 105 can flow to the reservoir 21 via lines 115 and 117, relieving pressure in the lines. The user can determine when the pressure has been fully relieved by reading the pressure gage 99. Once pressure is relieved, the user disconnects the coupling 93. As will apparent to those skilled in the art, as pressure acting against the valve member 79 decreases, the force generated by the spring 87 eventually overcomes the pressure, forcing the member 79 away from the seat 77 and resetting the shut-off valve 55.

As will be appreciated by those skilled in the art, the lubricant reservoir refilling system described above has several advantages over many prior commercially available refilling systems. The use of a shut-off valve reduces lubricant waste compared to prior systems having an overfill passage for dumping lubricant from the reservoir when filled beyond capacity. Because the shut-off valve is opened and shut by movement of the follower, no complicated and expensive electrical shut-off mechanisms are required. Further, the refilling system described above can be operated by a single user. In addition, the pressure relief valve vents back into the reservoir, thus eliminating waste and hazardous draining of lubricant.

Having described the invention in detail, it will be apparent that modifications and variations are possible without departing from the scope of the invention defined in the appended claims.

When introducing elements of the present invention or the preferred embodiments(s) thereof, the articles “a”, “an”, “the”, and “said” are intended to mean that there are one or more of the elements. The terms “comprising”, “including”, and “having” are intended to be inclusive and mean that there may be additional elements other than the listed elements.

In view of the above, it will be seen that the several objects of the invention are achieved and other advantageous results attained.

As various changes could be made in the above constructions without departing from the scope of the invention, it is intended that all matter contained in the above description and shown in the accompanying drawings shall be interpreted as illustrative and not in a limiting sense.

What is claimed is:

1. A lubricant reservoir system, comprising:
a reservoir for containing lubricant, said reservoir including a top, a bottom, a peripheral wall, and an inlet for delivering lubricant to the reservoir from a supply;
a follower in the reservoir slidingly and sealingly engaging the peripheral wall of the reservoir, the follower moving up and down in the reservoir in response to a changing level of lubricant in the reservoir;
a shut-off valve in fluid communication with the inlet for selectively preventing lubricant flow through the inlet, said valve being operatively connected to the follower for closing the valve and preventing lubricant flow through the inlet when lubricant in the reservoir reaches a predetermined level.

2. A lubricant reservoir system as set forth in claim 1, further comprising an actuator operatively connecting the follower to the shut-off valve to close the shut-off valve when lubricant in the reservoir reaches a predetermined level.

3. A lubricant reservoir system as set forth in claim 2, wherein the actuator comprises a lever pivotally connected to the reservoir and positioned for engagement by the follower.

4. A lubricant reservoir system as set forth in claim 3, wherein the actuator is positioned for engagement by the follower adjacent a center of the follower to avoid tilting the follower upon engagement.

5. A lubricant reservoir system as set forth in claim 3, wherein the shut-off valve further comprises a rod slidably positioned in the shut-off valve for engagement by the actuator when the follower is in a raised position.

6. A lubricant reservoir system as set forth in claim 5, wherein the lever has a roller positioned for engaging the rod.

7. A lubricant reservoir system as set forth in claim 1, further comprising a coupling in fluid communication with the reservoir inlet for selectively connecting the reservoir inlet to the lubricant source.

8. A lubricant reservoir system as set forth in claim 7, further comprising a pressure relief valve connected between the reservoir inlet and the coupling for relieving pressure prior to separating the coupling.

9. A lubricant reservoir system as set forth in claim 8, wherein the pressure relief valve vents back into the reservoir.

10. A lubricant reservoir system as set forth in claim 8, wherein the pressure relief valve vents back to the inlet of the reservoir.

11. A lubricant reservoir system as set forth in claim 1, further comprising a pump mounted on the reservoir for selectively pumping lubricant from the reservoir.

12. A lubricant reservoir system, comprising:
a reservoir for containing lubricant, said reservoir including a top, a bottom, a peripheral wall, and an inlet adapted for receiving lubricant to fill the reservoir;
a follower in the reservoir above lubricant in the reservoir, the follower moving up and down in the reservoir in response to a changing level of lubricant in the reservoir;
a shut-off valve operatively connected to the reservoir inlet, said shut-off valve having an open position permitting flow of lubricant to the inlet of the reservoir and a closed position preventing flow of lubricant to the inlet of the reservoir; and
an actuator positioned in the reservoir and operatively connected between the follower and the shut-off valve for opening and closing the valve in response to movement of the follower to a predetermined level of lubricant in the reservoir.

13. A lubricant reservoir system as set forth in claim 12, further comprising:
a coupling fluidly connecting the reservoir inlet to the supply; and
a pressure relief valve fluidly connecting the coupling to the reservoir inlet for reducing pressure at the coupling before disconnecting the coupling.

14. A lubricant reservoir system as set forth in claim 12, wherein the actuator comprises a lever pivotally connected to the reservoir and positioned for engagement by the follower to close the shut-off valve when lubricant in the reservoir reaches a predetermined level.

15. A lubricant reservoir system as set forth in claim 14, wherein the actuator is positioned for engagement by the follower adjacent a center of the follower to avoid tilting the follower upon engagement.

16. A lubricant reservoir system as set forth in claim 14, wherein the shut-off valve further comprises a rod slidably positioned in the shut-off valve for engagement by the actuator when the follower is in a raised position.

17. A lubricant reservoir system as set forth in claim 16, wherein the lever has a roller positioned for engaging the rod.

18. A lubricant reservoir system as set forth in claim 13, wherein the pressure relief valve vents back into the reservoir.

19. A lubricant reservoir system as set forth in claim 13, wherein the pressure relief valve vents back to the inlet of the reservoir.

20. A lubricant reservoir system as set forth in claim 12, further comprising a pump mounted on the reservoir for selectively pumping lubricant from the reservoir.
